(19) United States
(12) Patent Application Publication
(10) Pub. No.: US 2010/0019653 A1
(43) Pub. Date: Jan. 28, 2010

(54) Electron emission display and method of fabricating the same

(76) Inventor: Kyu Won Jung, Kyunggi-do (KR)

Correspondence Address: ROBERT E. BUSHNELL & LAW FIRM, 2029 K STREET NW, SUITE 600, WASHINGTON, DC, 20006-1004, US

(21) Appl. No.: 11/213,920

(22) Filed: Aug. 30, 2005

(30) Foreign Application Priority Data
Sep. 30, 2004 (KR) 2004-78062

(51) Int. Cl. H01J 1/62; H01J 9/02; H01J 1/00; H01J 21/10; H01J 9/24

(52) U.S. Cl. 313/496; 313/310; 313/235; 313/306; 445/24

(57) ABSTRACT

An electron emission display comprises: a cathode substrate having at least one electron emission device; a lower partition wall selectively formed in a predetermined region on the cathode substrate; an anode substrate having an image display region corresponding to the electron emission device; and an upper partition wall selectively formed on the anode substrate facing the cathode substrate. The lower and upper partition walls support the cathode and anode substrates, and maintain a predetermined space between the cathode and anode substrates, and the lower and upper partition walls comprise foam glass. With this configuration, a partition wall instead of a spacer is formed by selectively etching the foam glass, and is used for supporting a substrate, thereby eliminating a process of loading the spacer. A method of fabricating the electron emission display comprises steps for forming each of the aforementioned elements, as described above.

### CLAIM OF PRIORITY

This application makes reference to, incorporates the same herein, and claims all benefits accruing under 35 U.S.C. § 119 from an application for ELECTRON EMISSION DISPLAY AND METHOD OF FABRICATING THE SAME earlier filed in the Korean Intellectual Property Office on the 29 Sep., 2004 and there duly assigned Serial No. 2004-78062.

### BACKGROUND OF THE INVENTION

1. Technical Field

The present invention relates to an electron emission display and a method of fabricating the same and, more particularly, to an electron emission display and a method of fabricating the same, in which a partition wall instead of a spacer is formed by selectively etching foam glass, and is used for supporting a substrate, thereby eliminating a process of loading the spacer.

2. Related Art

Generally, an electron emission device is classified into a thermionic cathode type or a cold cathode type, wherein the thermionic cathode type and the cold cathode type employ a thermionic cathode and a cold cathode, respectively, as an electron emission source.

A cold cathode type electron emission device includes a structure such as a field emitter array (FEA), a surface conduction emitter (SCE), a metal insulator metal (MIM), a metal insulator semiconductor (MIS), a ballistic electron surface emitting (BSE), etc.

By using such electron emission devices, an electron emission display, various backlights, an electron beam unit for lithography, etc. can be realized. Among them, the electron emission display includes a cathode substrate provided with the electron emission device to emit electrons, and an anode substrate provided with a fluorescent layer with which the emitted electrons collide so as to emit light. In a general electron emission display, the cathode substrate has a matrix shape wherein cathode electrodes intersect gate electrodes, and a plurality of electron emission devices are defined in these intersection regions. Furthermore, the anode substrate includes the fluorescent layer and an anode electrode connected to the fluorescent layer, so that the anode electrode accelerates the electrons emitted from the electron emission device toward the fluorescent layer formed on the anode substrate. The electron emission display selectively drives the intersection regions to display an image. In the meantime, a spacer is provided between the cathode substrate and the anode substrate in order to uniformly space the cathode substrate and the anode substrate apart from each other at a predetermined distance. In this respect, the spacer prevents deformation and damage due to pressure difference between the interior and the exterior when the cathode substrate and the anode substrate are packaged in a high vacuum. Furthermore, the spacer maintains a uniform space between two substrates, thereby suppressing non-uniformity of brightness due to emitting positions.

In the conventional electron emission display, the spacers are individually formed one by one, or formed by a screen-printing method. In the method of forming the spacers individually, paste is applied to the spacer, and then the spacer is fixed by being arranged and mounted in a predetermined position of the substrates. However, this method requires processes of applying the paste, and arranging and loading the spacer, so that it takes a relatively great period of time to fabricate the electron emission display in its entirety. Furthermore, the substrate may be stained because of an error in arranging the spacer and a blot of the paste applied to the spacer. In addition, the spacer should be correctly arranged between light-shielding films of the anode substrate, and therefore high precision and very expensive equipment are required. Also, in the screen-printing method, the screen-printing process be repeated many times to satisfy a requirement for a fine pitch, and the maximum height of the spacer is limited.

### SUMMARY OF THE INVENTION

Accordingly, it is an aspect of the present invention to provide an electron emission display in which a partition wall, instead of a spacer, is formed by selectively etching foam glass, and is used for supporting a substrate.

In accordance with another aspect of the present invention, a method of fabricating an electron emission display, the fabricating process is simplified by eliminating a process of loading the spacer.

In accordance with a first aspect of the present invention, an electron emission display comprises: a cathode substrate having at least one electron emission device; a lower partition wall selectively formed in a predetermined region on the cathode substrate; an anode substrate having an image display region corresponding to the electron emission device; and an upper partition wall selectively formed on the anode substrate and facing the cathode substrate. The lower and upper partition walls support the cathode and anode substrates and maintain a predetermined space between the cathode and anode substrates, and the lower and upper partition walls include a foam glass.

Preferably, the lower and upper partition walls are formed with a stripe shape. The lower and upper partition walls intersect each other. The lower partition wall has a thickness of 10 μm thru 40 μm. The upper partition wall has a thickness of 0.5 mm thru 2.5 mm. The electron emission device comprises: an emitter; a first electrode connected to the emitter; and a second electrode insulated from the first electrode and causing electrons to be emitted from the emitter. The image display region comprises: a fluorescent layer emitting light by electrons emitted from the electron emission device; and an anode electrode connected to the fluorescent layer. The electron emission display further comprises a third electrode for focusing electrons emitted from the electron emission device.

In accordance with a second aspect of the present invention, a method of fabricating an electron emission display comprises the steps of: forming a cathode substrate having at least one electron emission device; selectively forming a lower partition wall, including foam glass, on the cathode substrate; forming an anode substrate facing the cathode substrate and having an image display region thereon; selectively forming an upper partition wall using foam glass on the anode substrate; and packaging the cathode substrate with the lower partition wall and the anode substrate with the upper partition wall so that the lower and upper partition walls intersect each other.

Preferably, the step of forming the lower partition wall comprises: applying the foam glass on the cathode substrate; and selectively wet-etching the foam glass. The step of forming the lower partition wall comprises: applying the foam glass on the anode substrate; and selectively wet-etching the foam glass. The method further comprises forming a third electrode for focusing electrons emitted from the electron emission device.

In accordance with a third aspect of the present invention, a method of fabricating an electron emission display comprises the steps of: forming a first electrode, an insulating layer, and a second electrode intersecting the first electrode on a first substrate in sequence; forming a hole to expose a portion of the first electrode in a region where the first electrode intersects the second electrode; selectively forming a lower partition wall on the insulating layer or the second electrode; forming an emitter connected to the first electrode within the hole; forming a second substrate facing the first substrate; forming a third electrode on the second substrate; selectively forming an upper partition wall on the third electrode; forming an image display region between the upper partition walls so as to display an image based on electrons emitted from the emitter; and packaging the first substrate with the lower partition wall and the second substrate with the upper partition wall so that they are spaced apart from each other by the lower and upper partition walls, wherein the lower and upper partition walls include a foam glass.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial perspective view of an electron emission display according to an embodiment of the present invention;

FIG. 2A is a plan view of the electron emission display of FIG. 1;

FIG. 2B is a sectional view of the electron emission display taken along line I-I of FIG. 2A;

FIG. 2C illustrates an electron emission device in the electron emission display of FIG. 2A;

FIGS. 3A thru 3I illustrate a process of fabricating a cathode substrate of the electron emission display according to an embodiment of the present invention; and

FIGS. 4A thru 4C illustrate a process of fabricating an anode substrate of the electron emission display according to an embodiment of the present invention.

### DETAILED DESCRIPTION OF THE INVENTION

Hereinafter, preferable embodiments of the present invention will be described with reference to the accompanying drawings, the preferred embodiments of the present invention being provided so as to be readily understood by those skilled in the art.

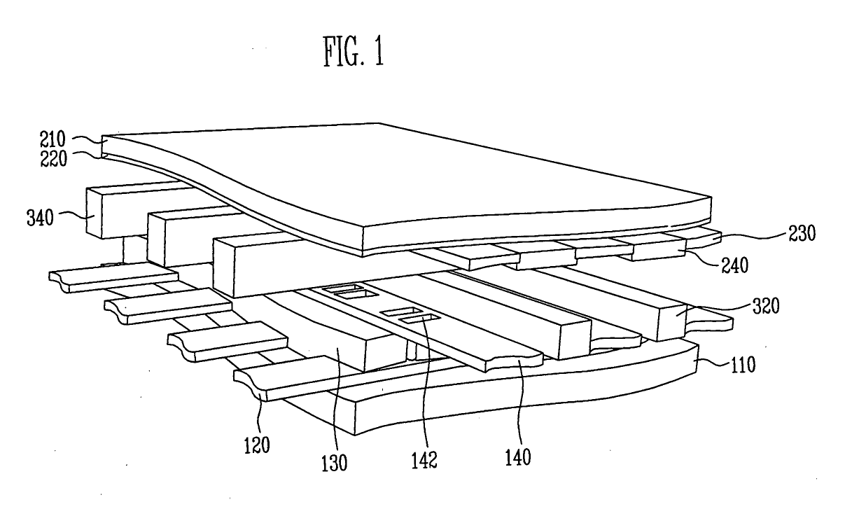

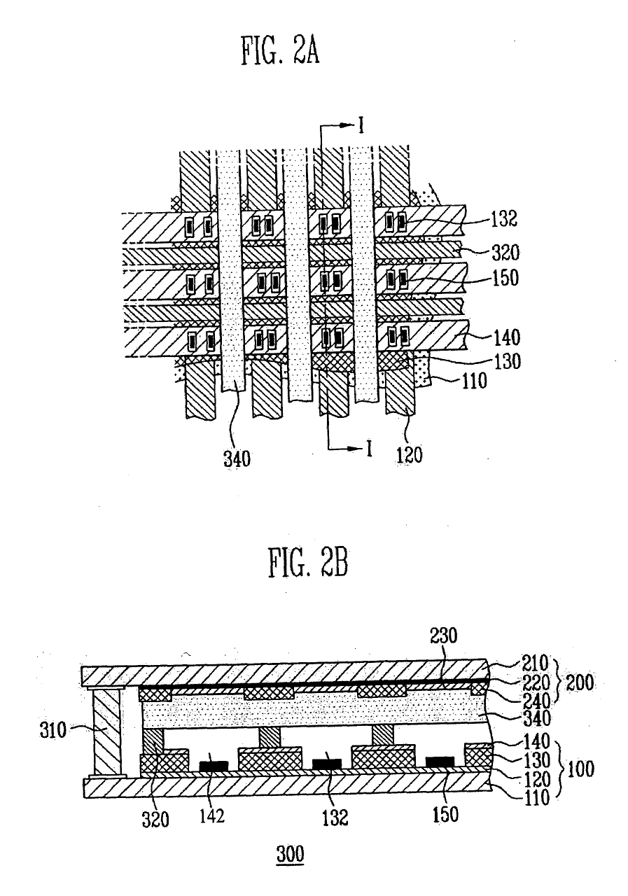

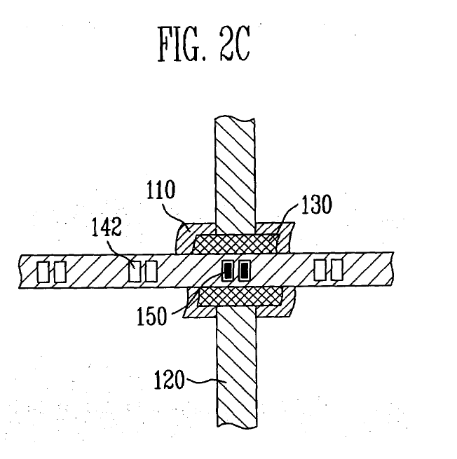

FIG. 1 is a partial perspective view of an electron emission display according to an embodiment of the present invention; FIG. 2A is a plan view of the electron emission display of FIG. 1; FIG. 2B is a sectional view of the electron emission display taken along line I-I of FIG. 2A; and FIG. 2C illustrates an electron emission device in the electron emission display of FIG. 2A.

Referring to FIGS. 1 and 2A thru 2C, an electron emission display according to an embodiment of the present invention includes a cathode substrate 100 provided with at least one electron emission device, a lower partition wall 320 selectively formed in a predetermined region on the cathode substrate 100, an anode substrate 200 forming an image display region corresponding to the electron emission device, and an upper partition wall 340 selectively formed on the anode substrate 200 facing the cathode substrate 100, wherein the lower partition wall 320 and the upper partition wall 340 support the cathode substrate 100 and the anode substrate 200. The lower partition wall 320 and the upper partition wall 340 comprise foam glass.

In more detail, the cathode substrate 100 includes a rear substrate 110, a cathode electrode 120, an insulating layer 130, a gate electrode 140, and an emitter 150. Furthermore, the lower partition wall 320 is arranged on the cathode substrate 100.

At least one cathode electrode 120 is arranged on the rear substrate 110, and has a predetermined shape, e.g. a stripe shape. The substrate is a glass or silicon substrate. Particularly, when the emitter 150 is formed by rear-side exposure to photosensitive carbon nanotube (CNT) paste, a transparent substrate such as a glass substrate is preferably employed.

The cathode electrodes 120 are used for transmitting a data signal from a data driver (not shown) or a scan signal from a scan driver (not shown) to the electron emission device. The electron emission device is defined in a region where the cathode electrode 120 intersects the gate electrode 140. The cathode electrode 120, like the substrate 110, is made of a transparent material such as indium tin oxide (ITO).

The insulating layer 130 is formed on the substrate 110 and the cathode electrode 120, and electrically insulates the cathode electrode 120 from the gate electrode 140. The insulating layer 130 is formed with at least one first hole 132 in the region where the cathode electrodes 120 intersect the gate electrodes 140, thereby exposing the cathode electrode 120 thru the first hole 132.

The gate electrodes 140 are formed on the insulating layer 130, have a predetermined shape, e.g., a stripe shape, and intersect the cathode electrodes 120. Each gate electrode 140 transmits the data signal from the data driver, and the scan signal from the scan driver, to a pixel. The gate electrode 140 is made of good conductive metal, e.g., at least one selected from gold (Au), silver (Ag), platinum (Pt), aluminum (Al), chrome (Cr), and an alloy thereof. Furthermore, the gate electrode 140 is formed with at least one second hole 142 corresponding to the first hole 132, thereby exposing the cathode electrode 120 thru the second hole 142.

The emitter 150 is formed on, and is electrically connected to, the cathode electrode 120. Preferably, the emitter 150 is made of: carbon nanotube; nanotube of graphite, diamond, diamond-like-carbon or combination thereof; or a nanowire of silicon (Si) or silicon carbide (SiC). When an electric field is formed by a voltage applied between the cathode electrode 120 and the gate electrode 140, the emitter 150 emits the electrons, so that the emitted electrons collide with the fluorescent layer 230 corresponding to the emitter 150, thereby displaying a predetermined image.

Meanwhile, in the region where the cathode electrode 120 intersects the gate electrode 140, the electron emission device includes the cathode electrode 120, the emitter 150 connected to the cathode electrode 120, and the gate electrode 150 driving the electrons to be emitted from the emitter 150. In this respect, the cathode substrate 100 is driven in correspondence to at least one electron emission device arranged in a matrix shape, and the anode substrate 200 is provided with the image display region defined in correspondence to the electron emission device.

The lower partition wall 320 is formed on the insulating layer 130 or the gate electrode 140, and has a predetermined shape, e.g., a stripe shape. Furthermore, the lower partition wall 320 is made of material including foam glass. Foam glass is an insulating material having good physical characteristics. For example, foam glass is used in a plasma display panel (PDP) to form a partition wall at a low cost.

Furthermore, the lower partition wall 320 is formed so as to have a stripe shape or a divided stripe shape, but is not limited thereto. However, the stripe shape or a similar shape is preferable in order to prevent the rear substrate 110 or a front substrate 210 from being deformed or sagging due to its own weight.

Preferably, the lower partition wall 320 has a thickness of 10 μm thru 40 μm.

The anode substrate 200 includes the front substrate 210, an anode electrode 220, and the fluorescent layer 230. Furthermore, the upper partition wall 340 is arranged on the anode substrate 200.

The anode electrode 220 is formed on the entire surface of the front substrate 210, and accelerates the electrons emitted from the emitter 150 toward the fluorescent layer 230. Preferably, the anode electrode 220 is made of a transparent material, e.g, ITO.

The fluorescent layer 230 is selectively arranged on the front substrate 210 at predetermined intervals, and emits light due to the collision of the electrons emitted from the emitter 150 with layer 230. Preferably, the front substrate 210 is made of a transparent material.

The light-shielding films 240 are optionally provided, and are arranged between the fluorescent layers 230 at predetermined intervals, thereby absorbing/intercepting external light and preventing close-talk so as to enhance contrast.

Furthermore, the anode substrate 200 is provided with an image display region corresponding to the electron emission device. In this respect, the image display region includes the fluorescent layer 230 which emits light due to collision of the electrons emitted from the emitter 150 with layer 230, and the anode electrode 220 connected to the fluorescent layer 230.

The upper partition wall 340 is formed on the front substrate 210, has a predetermined shape, e.g., a stripe shape, and intersects with the lower partition wall 320. Like the lower partition wall 320, the upper partition wall 340 is also formed to have a stripe shape, and comprises foam glass.

Preferably, the upper partition wall 340 has a thickness of 0.5 mm thru 2.5 mm.

The lower and upper partition walls 320 and 340, respectively, prevent deformation and damage due to pressure difference between the interior and the exterior when the cathode substrate 100 and the anode substrate 200 are packaged in a high vacuum. Furthermore, the lower and upper partition walls 320 and 340, respectively, maintain a uniform space between the cathode substrate 100 and the anode substrate 200, thereby suppressing non-uniformity of brightness due to emitting positions.

In the electron emission display 300, an external power source (not shown) applies a positive (+) voltage to the cathode electrode 120, a negative (−) voltage to the gate electrode 140, and the positive (+) voltage to the anode electrode 220. Thus, an electric field is formed around the emitter due to the voltage difference between the cathode electrode 120 and the gate electrode 140, thereby causing the emitter 150 to emit light. The emitted electrons collide with the corresponding fluorescent layer 230 due to the high voltage applied to the anode electrode 220, thereby emitting light and displaying a predetermined image.

A grid electrode (not shown) may be additionally formed between the lower partition wall 320 and the upper partition wall 340 so as to protect the electrodes from arcing.

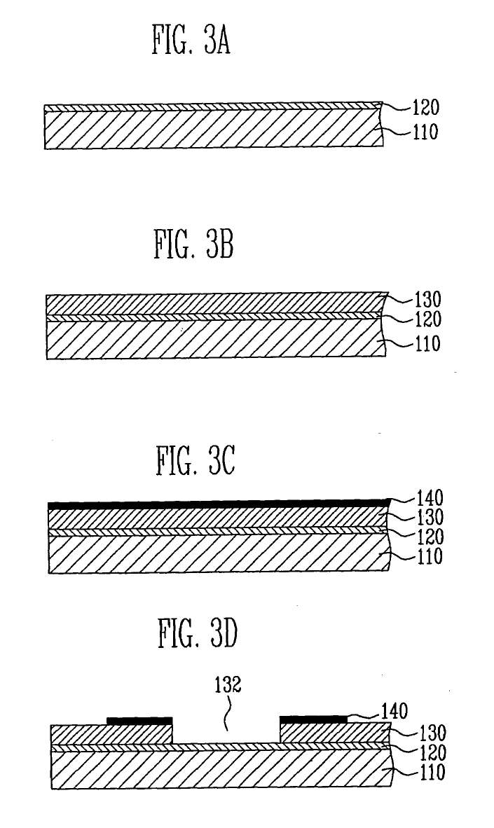

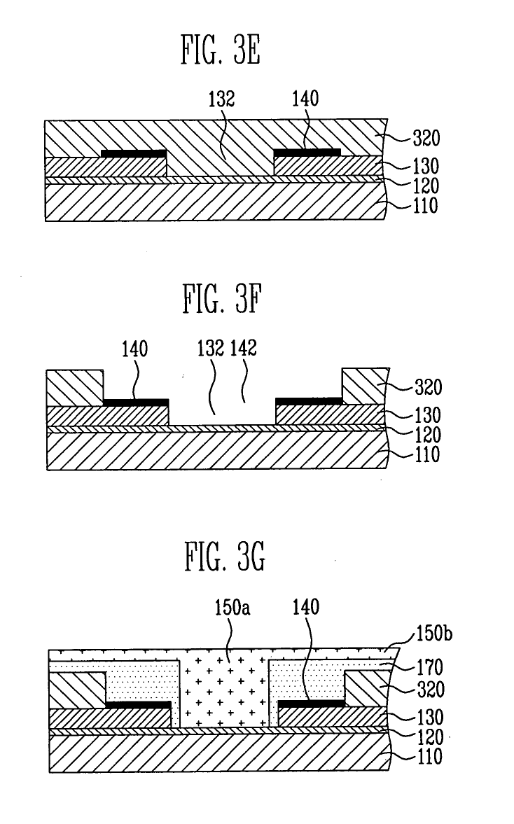

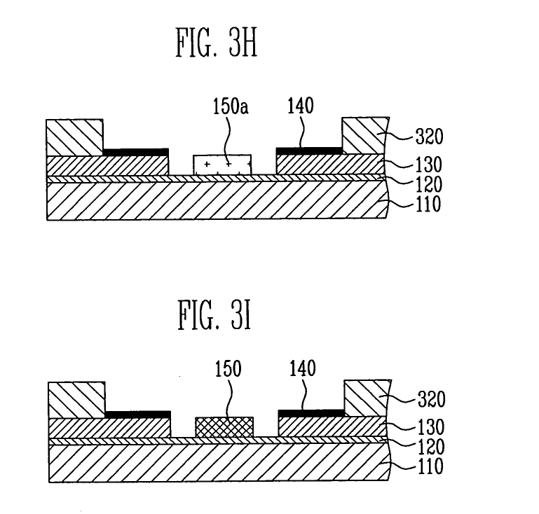

The foregoing electron emission display is fabricated by: forming a cathode electrode having at least one electron emission device thereon; selectively forming a lower partition wall using foam glass on the cathode substrate; forming an anode substrate facing the cathode substrate and provided with an image display region; selectively forming an upper partition wall using foam glass on the anode substrate; and packaging the lower partition wall of the cathode substrate and the upper partition wall of the anode substrate so as to intersect with each other. Below, the detailed fabricating process will be described with reference to FIGS. 3A thru 4C.

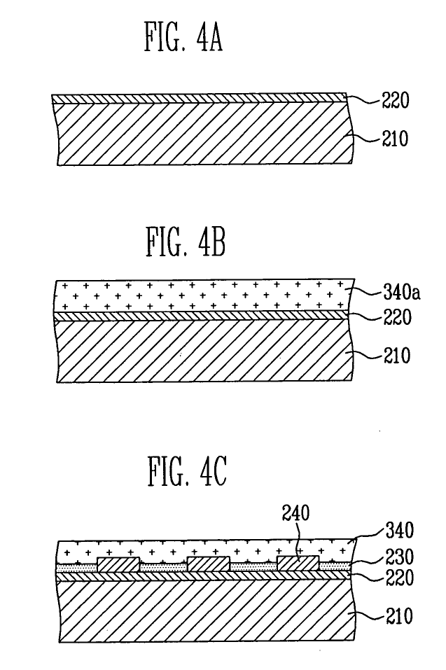

FIGS. 3A thru 3I illustrate a process of fabricating a cathode substrate of the electron emission display according to an embodiment of the present invention; and FIGS. 4A thru 4C illustrate a process of fabricating an anode substrate of the electron emission display according to an embodiment of the present invention.

Referring to FIGS. 3A thru 4C, the fabricating method according to an embodiment of the present invention comprises the steps of: forming the cathode electrode 120, the insulating layer 130, and the gate electrode 140 intersecting the cathode electrode 120 on the rear substrate 110 in sequence; forming the first hole 132 in the region where the cathode electrode 120 intersects the gate electrode 140 so as to expose a portion of the cathode electrode 120; selectively forming the lower partition wall 320 on the insulating layer 130 or the cathode electrode 140; forming the emitter 150 connected to the cathode electrode 120 within the first hole 132; forming the front substrate 210 facing the rear substrate 110; forming the anode electrode 220 on the front substrate 210; selectively forming the upper partition wall 340 on the anode electrode 220; forming the image display region between the upper partition walls 340 so as to display an image based on the electrons emitted from the emitter 150; and packaging the rear substrate 110 and the front substrate 210 so that they are spaced apart from each other by the lower partition wall 320 and the upper partition wall 340, wherein the lower partition wall 320 and the upper partition wall 340 comprise foam glass.

Referring to FIG. 3A, the cathode electrode 120 is formed on the substrate 110 so as to have a predetermined shape, e.g., a stripe shape. An etching mask is formed by applying, exposing and developing photoresist, and a line patterning process is performed using the etching mask, thereby forming the cathode electrode 120.

Referring to FIG. 3B, the insulating layer 130 is formed on the substrate 110 and the cathode electrode 120 so as to have a predetermined thickness. In the case of a thick film process, the insulating material of a paste state is applied by a screen-printing method so as to have a predetermined thickness, and is then annealed at a predetermined temperature. In the case of a thin film process, the insulating layer is deposited by chemical vapor deposition (CVD) so as to have a predetermined thickness.

Referring to FIG. 3C, conductive metal is deposited by a sputtering method so as to have a predetermined thickness on the insulating layer 130. The gate electrode 140 is made of metal which has good conductivity and which is easy to pattern, e.g. at least one selected from gold (Au), silver (Ag), platinum (Pt), aluminum (Al), chrome (Cr), and an alloy thereof.

Referring to FIG. 3D, an etching mask is formed by applying, exposing and developing a photoresist, and the gate electrode 140 and the insulating layer 130 are etched so as to expose a portion of the cathode electrode 120, thereby forming at least one first hole 132 having a predetermined diameter. The first hole 132 is formed in a region where the cathode electrode 120 intersects the gate electrode 140. Then, the etching mask having a predetermined shape is formed by applying, exposing and developing the photoresist, and the gate electrode 140 is line-patterned through the etching mask, thereby forming the gate electrode 140 having a predetermined shape, e.g., the stripe shape. In this respect, the gate electrode 140 is formed on the insulating layer 130 in a direction substantially intersecting the cathode electrode 120.

Referring to FIG. 3E, the foam glass 320a is applied to the entire surface of the structure of FIG. 3D.

Referring to FIG. 3F, the foam glass 320a is selectively wet-etched to form the lower partition wall 320 having the stripe shape. In this respect, the wet-etching patterning method is preferable so as to minimize staining resulting from the etching process.

Referring to FIG. 3G, a photosensitive material, e.g., the photoresist, is applied to the entire surface of the result shown in FIG. 3F, and is then patterned to form a sacrificial layer 170 exposing a portion of the cathode electrode 170, thereby defining an electron emission region. Then, a photosensitive emission material 150a, 150b is applied to the patterned sacrificial layer 170 by the screen-printing method. The rear surface of the rear substrate 110 is then exposed to an ultraviolet (UV) ray using the parasitic layer 170 as a mask, thereby selectively exposing the electron emission material 150a, 150b. In this respect, the portion 150a of the electron emission material 150a, 150b exposed to the UV ray has a negative polarity, and is thus not dissolved in a developer.

Referring to FIG. 3H, the exposed electron emission material 150a is hardened, and the exposure depth thereof is adjusted according to the intensity of the UV ray. On the other hand, the non-exposed electron emission material 150b is dissolved in the developer, e.g., acetone, Na₂CO₃, or NaOH. Preferably, the sacrificial layer 170 is also dissolved while the non-exposed electron emission material 150b is dissolved.

Referring to FIG. 3I, the exposed electron emission material is annealed at a predetermined temperature, thereby forming the emitter 150 having a desired height.

Through the fabrication process shown in FIGS. 3A thru 3I, the cathode substrate having the electron emission devices arranged as a matrix structure thereon is completely fabricated.

Referring to FIG. 4A, the anode electrode 220 made of a transparent material, e.g., an ITO electrode, is formed on the front substrate 210.

Referring to FIG. 4B, the foam glass 340a is applied to the anode electrode 220, thereby forming a predetermined layer.

Referring to FIG. 4C, the foam glass 340a is selectively wet-etched to form the upper partition wall 340 having the stripe shape. Then, the fluorescent layer 230 and the light-shielding film 240 are selectively formed.

Through the fabrication process shown in FIGS. 4A thru 4C, the anode substrate provided with the image display region corresponding to the electron emission device is completely fabricated. Thereafter, the cathode substrate wall with the lower partition wall and the anode substrate with the upper partition wall are packaged by a sealing material (not shown) so as to be spaced apart from each other by the lower partition and the upper partition wall, thereby completing the electron emission display.

The foregoing fabrication process may additionally include forming the grid electrode between the lower partition wall 320 and the upper partition wall 340 in order to focus the electrons emitted from the electron emission device.

As described above, when the electron emission display is fabricated by the method according to an embodiment of the present invention, the cathode substrate fabrication process and the anode substrate fabrication process are performed without a process of loading a separate spacer, thereby improving the fabricating process yield for the electron emission display. Furthermore, the spacer is replaced by the upper and lower partition walls while the cathode substrate and the anode substrate are packaged, thereby preventing the substrate from being damaged.

In the aforementioned embodiments, the electron emission display has such a structure that the fluorescent layer and the anode electrode connected to the fluorescent layer are formed on the front substrate, but it is not limited thereto. Alternatively, the electron emission display may have various structures as long as the electrons emitted from the emitter can collide with the fluorescent layer of the front substrate.

As described above, the present invention provides an electron emission display employing a partition wall comprising foam glass instead of a spacer so that light is prevented from being abnormally emitted due to the spacer, and the electrons are prevented from being accumulated in the spacer.

Furthermore, the present invention provides a method of fabricating the electron emission display, in which method the partition wall is used as an alternative to the spacer so that the substrate is prevented from being damaged while the cathode substrate and the anode substrate are packaged, and there is no need for a separate process of loading the spacer, so that the fabricating process yield is improved.

While the invention has been described in connection with certain exemplary embodiments, it is to be understood by those skilled in the art that the invention is not limited to the disclosed embodiments, but, on the contrary, it is intended to cover various modifications included within the sprit and scope of the appended claims and equivalents thereof.

1. An electron emission display, comprising:
a cathode substrate having at least one electron emission device;
lower partition walls selectively formed in a predetermined region on the cathode substrate and having a length extending in a first direction;
an anode substrate having an image display region corresponding to said at least one electron emission device; and
upper partition walls selectively formed between the lower portion walls and the anode substrate and facing the cathode substrate, and having a length extending in a second direction perpendicular to the first direction;
wherein the lower partition walls and the upper partition walls support the cathode substrate and the anode substrate, and maintain a predetermined space between the cathode substrate and the anode substrate.

2. The electron emission display according to claim 1, wherein each of the lower partition walls and the upper partition walls are formed so as to have a stripe shape.

3. (canceled)

4. The electron emission display according to claim 1, wherein the lower partition walls have a thickness in a range of 10 μm thru 40 μm.

5. The electron emission display according to claim 1, wherein the upper partition walls have a thickness in a range of 0.5 mm thru 2.5 mm.

6. The electron emission display according to claim 1, wherein said at least one electron emission device comprises:
an emitter;
a first electrode connected to the emitter; and
a second electrode insulated from the first electrode and causing electrons to be emitted from the emitter.

7. The electron emission display according to claim 1, wherein the image display region comprises:
a fluorescent layer for emitting light by electrons emitted from said at least one electron emission device; and
an anode electrode connected to the fluorescent layer.

8. The electron emission display according to claim 1,
further comprising an electrode for focusing electrons emitted from said at least one electron emission device.

9. A method of fabricating an electron emission display, comprising the steps of:
(a) forming a cathode substrate having at least one electron emission device;
(b) selectively forming a lower partition wall on the cathode substrate so that the lower partition wall extends in a first direction;
(c) forming an anode substrate facing the cathode substrate, and having an image display region thereon; and
(d) selectively forming an upper partition wall on the anode substrate so that the upper partition wall extends in a second direction perpendicular to the first direction.

10. The method according to claim 9, wherein step (b) comprises:
applying foam glass on the cathode substrate; and
selectively wet-etching the foam glass.

11. The method according to claim 9, wherein step (d) comprises:
applying foam glass on the anode substrate; and
selectively wet-etching the foam glass.

12. The method according to claim 9, further comprising forming a third electrode to focus electrons emitted from said at least one electron emission device.

13. A method of fabricating an electron emission display, comprising the steps of:
forming a first electrode, an insulating layer, and a second electrode intersecting the first electrode on a first substrate in sequence;
forming a hole to expose a portion of the first electrode in a region where the first electrode intersects the second electrode;
selectively forming a lower partition wall on one of the insulating layer and the second electrode so that the lower partition wall extends in a first direction;
forming an emitter connected to the first electrode within the hole;
forming a second substrate facing the first substrate;
forming a third electrode on the second substrate;
selectively forming an upper partition wall on the third electrode so that the upper partition wall extends in a second direction perpendicular to the first direction;
forming an image display region between adjacent upper partition walls so as to display an image based on electrons emitted from the emitter; and
packaging the first substrate with the lower partition wall and the second substrate with the upper partition wall so that the first substrate and the second substrate are spaced apart from each other by the lower partition wall and the upper partition wall

14. The method according to claim 13, wherein at least one of the lower partition wall and the upper partition wall is formed by selectively wet-etching foam glass.

15. The method according to claim 13, wherein the third electrode is formed to focus electrons emitted from said at least one electron emission device.

16. An electron emission display fabricated according to the method of claim 9, wherein the lower partition wall and the upper partition wall are disposed one on top of the other, support the cathode substrate and the anode substrate, and maintain a predetermined space between the cathode substrate and the anode substrate.

17. An electron emission display fabricated according to the method of claim 9, wherein the image display region comprises:
an emitter;
a first electrode connected to the emitter; and
a second electrode insulated from the first electrode and causing electrons to be emitted from the emitter.

18. An electron emission display fabricated according to the method of claim 9, wherein the image display region comprises:
a fluorescent layer for emitting light by electrons emitted from said at least one electron emission device; and
an anode electrode connected to the fluorescent layer.

19. An electron emission display fabricated according to the method of claim 13, wherein the lower partition wall and the upper partition wall are disposed one on top of the other, support the cathode substrate and the anode substrate, and maintain a predetermined space between the cathode substrate and the anode substrate.

20. An electron emission display fabricated according to the method of claim 13, wherein the image display region comprises:
the first electrode connected to the emitter;
the second electrode insulated from the first electrode and causing electrons to be emitted from the emitter;
a fluorescent layer for emitting light by electrons emitted from said at least one electron emission device; and
an anode electrode connected to the fluorescent layer.

21. (canceled)

22. An electron emission display fabricated according to the method of claim 9, wherein the upper partition wall has a thickness in a range of 0.5 mm thru 2.5 mm.

23-24. (canceled)

25. An electron emission display fabricated according to the method of claim 13, wherein the upper partition wall has a thickness in a range of 0.5 mm thru 2.5 mm.

26. (canceled)

27. The electron emission display according to claim 1, wherein each of the lower partition walls and the upper partition walls is formed of foam glass.
